(19) United States
(12) Patent Application Publication
(10) Pub. No.: US 2026/0162237 A1
(43) Pub. Date: Jun. 11, 2026

(54) Device and method for testing the spray jet of an assembly of spray applicators

(71) Applicant: Harro Höfliger Verpackungsmaschinen GmbH, Allmersbach im Tal (DE)

(72) Inventors: Bernd POHL, Allmersbach im Tal (DE); Bernd PRÖGER, Sulzbach an der Murr (DE)

(73) Assignee: Harro Höfliger Verpackungsmaschinen GmbH, Allmersbach im Tal (DE)

(21) Appl. No.: 19/245,970

(22) Filed: Jun. 23, 2025

(30) Foreign Application Priority Data
Jun. 25, 2024 (EP) 24184279.8

(51) Int. Cl. G06T 7/00; G01M 99/00; G06T 7/62

(52) U.S. Cl. CPC G06T 7/0002; G01M 99/008; G06T 7/62

(57) ABSTRACT

A method for testing the spray jet of an assembly for spray applicators, includes the following method steps: The assembly to be tested is positioned in a receiving unit of a testing device and connected to a liquid reservoir. The assembly to be tested is tensioned and sucks in a specific volume of the test fluid from the liquid reservoir. The assembly to be tested is actuated, so that a spray jet is produced. The spray jet darkens a strip of light or a light beam of a light barrier. The darkening of the strip of light or the light beam is measured by means of a sensor unit and the measured values are registered as a function of time and evaluated. Based on the measured values determined, the start of the spray jet and/or the end of the spray jet and/or the duration of the spray jet is calculated.

### CROSS-REFERENCE TO RELATED APPLICATION

This application claims the benefit of European Patent Application EP 24184279.8, filed on Jun. 25, 2024, the content of which is incorporated in its entirety.

### TECHNICAL FIELD

The disclosure relates to a device and a method for testing the spray jet of an assembly of spray applicators. Such spray applicators can be in particular high-pressure atomizers such as inhalers but also sprays such as, for example, nose or eye sprays. Spray applicators are primarily used when the administration of an active substance is dose-dependent and/or depends on the droplet size.

### BACKGROUND

Inhalers are medical devices (applicators) for producing aerosols or vapors; the aerosols or vapors can then be breathed in by patients. Inhalers are used in particular in the treatment of various respiratory diseases such as, for example, asthma or COPD (chronic obstructive pulmonary disease). By means of the inhalers, active substances can reach the lungs, acting in a locally limited manner there. As a result, secondary effects can be reduced; also, frequently only a small dose of the active substance is required. The active substance can also reach the bloodstream via the alveoli of the lungs and act systemically there. Here too, relatively small doses are frequently sufficient, since the first-pass effect of the liver is circumvented. Moreover, because of the large resorption surface of the lungs, the active substances reach the bloodstream more quickly, so that the effect is established very rapidly.

The inhalers can be formed, for example, as soft mist inhalers (SMI, high-pressure atomizers). Inhalers of this type are described in particular in WO 91/14468 A1, WO 97/12687 A1 or WO 2009/047173 A2. The soft mist inhalers have an atomizer with a mechanical pump, by means of which a long-lasting fine spray cloud of a fluid can be produced. The fluid is generally an aqueous or ethanolic solution of the active substance. No propellant is needed for the production of the spray mist. The fluid is generally present in a cartridge. After such a cartridge has been used, this can frequently be replaced at least a few times.

The inhaler itself has a stable capillary, which is inserted into the cartridge having the fluid. The capillary dips a short distance into the fluid, so that the latter is drawn upward within the capillary by capillary forces. Located in the upper area of the capillary is a high-pressure check valve for metering the fluid. This check valve serves both to block and also to control the flow of the fluid within the capillary. The fluid can flow upward within the capillary but not back down again and therefore back into the cartridge again.

The upper end of the capillary ends in a high-pressure pump assembly, which represents the central unit of the soft mist inhaler—and also of the other spray applicators. The correct assembly of this pump assembly is critical for trouble-free functioning of the inhaler, so that even minor errors or deviations can lead to a malfunction of the inhaler.

Following the complete assembly of the inhaler, a quality test generally takes place. By means of the quality test, malfunctions of the inhaler can be discovered before delivery, so that no inhalers not meeting the specification reach the market. Furthermore, it is also necessary to ensure that the dosing of the fluid is carried out reproducibly. Such a test of the inhalers can be carried out within the context of full inspection (100% testing), in which all the inhalers are routinely appropriately tested. It would also be possible to perform the test on the inhalers within the context of random-sample tests.

WO 2017/060328 A1 and US 2019/223418 A1 disclose a testing system and a testing method in which the finally assembled inhaler is tested with a test fluid. The finished inhaler is connected to a test cartridge having the test fluid for this purpose, and is actuated mechanically several times. In the process, various measurements, in particular with regard to the distribution of the spray mist and the quantity of atomized fluid, are performed. If the inhaler does not supply any correct measured values during this testing, the inhaler is separated out.

In order to be able to detect malfunctions of individual important components as early as possible and to rectify them, individual tests of specific components are also known. DE 2020 210 028 U1 discloses a device for testing high-pressure check valves fixed to capillaries. In the event of a leak in the high-pressure check valve, the latter can be separated out directly. EP 4 109 066 A1 discloses a device for testing the tightness of a pump assembly for high-pressure spray applicators. As a result, the pump assembly can be tested for tightness separately from the further components of the spray applicators, so that only pump assemblies that meet the specification are used for the final assembly.

### SUMMARY

The application presents an improved testing method and an improved testing device for testing the spray jet of an assembly for spray applicators.

The method for testing the spray jet of an assembly for spray applicators has the following method steps:
1. The assembly to be tested is positioned in a receiving unit of a testing device and connected to a liquid reservoir.
2. The assembly to be tested is tensioned and sucks in a specific volume of the test fluid from the liquid reservoir.
3. The assembly to be tested is actuated, so that a spray jet is produced.
4. The spray jet darkens a strip of light or a light beam of a light barrier.
5. The darkening of the strip of light is measured by means of a sensor unit and the measured values are registered as a function of time and evaluated.
6. On the basis of the measured values determined, the start of the spray jet (t3) and/or the end of the spray jet (t4) and/or the duration of the spray jet is calculated.

The strip of light or the light beam can preferably be a laser beam or a fanned-out laser beam.

The measured values can in particular be evaluated by software and/or hardware.

Following the triggering of the spray jet, there are generally a few hundred milliseconds until a pressure has built up. There is then an abrupt rise in the darkening value, which is correlated with the start of the spray jet. In the case of a stable spray jet, the darkening value should remain approximately constant for a certain time. The darkening value then drops rapidly again.

From the recorded measured values for the darkening value, it is possible to determine via a plurality of algorithms the points P3 (time t3) as the start of the spray jet and P4 (time t4) as the end of the spray jet (falling below a defined threshold of the darkening value). As a result, at least the duration of the spray jet can be calculated. From these values, important findings relating to the quality of the assembly to be tested can be obtained. In particular, it is possible to ascertain whether the appropriate measured values each lie in a specified reference range or not. If the measured values lie within the specified reference range, the assembly to be tested has passed the first part of the testing method. If, on the other hand, the measured values lie outside the specified reference range, the assembly does not meet the required specifications and will be discarded.

The darkening values can be output in particular in the form of a diagram, in particular in the form of a line diagram, for this purpose. From the course of the lines, in addition to the values already mentioned, further findings can be obtained as a result, by means of which conclusions can be drawn as to the quality of the tested assembly. Alternatively or additionally, the darkening values can also be output in tabular form.

In particular, in this connection it is possible to ascertain whether the falling course of the lines of the darkening values toward the end of the spray jet lies in a specified reference range or not. If the values fall too quickly, the nozzle of the tested assembly is too wide. This can be the case, for example, when the nozzle cross section is outside the tolerance. On the other hand, if the values fall too slowly, the nozzle of the tested assembly is too narrow. This can be the case, for example, in the event of contamination of the nozzle or as a result of a production fault.

In a particularly preferred embodiment, the measured values determined can be integrated, at least in the range between the start of the spray jet (P3, t3) and the end of the spray jet (P4, t4); the integral of the measured values can then be evaluated.

By means of integration of the measured values during the duration of the spray jet, the quality of the spray jet can then be calculated. The integral of the measured values can preferably be output in the form of a line diagram. From the line course of the integral, further data can thus be calculated; in addition the line course of the integral can permit conclusions to be drawn about the tested assembly. Alternatively or additionally, the integral can also be output in tabular form.

In this connection, in particular the rise of the integral and the related line course during the rise of the integral can be considered. For example, it is possible to ascertain whether the rise of the integral lies in a specified reference range or not. Alternatively or additionally, it is possible to ascertain whether the rise of the integral runs approximately linearly. An approximately linear rise of the integral implies that a constant spray mist has been generated. This is the case only when the piston of the tested assembly moves continuously.

Alternatively or additionally, it is possible to ascertain whether the maximum of the integral lies in a specified reference range or not.

In a particularly advantageous embodiment, a further end point of the spray jet can be determined from the integral. For this purpose, for example, the transition point P7 of the integral (time t7) can be determined. This transition point P7 of the integral can be the region of the transition between an approximately linear rise of the integral in a curved rise of the integral. Alternatively or additionally, exceeding a defined percentage of the maximum of the integral can be determined as the end P6 of the spray jet (time t6). It is then possible to ascertain whether the points P6 and/or P7 lie in a specified reference range or not. Furthermore, the time interval between the start of the spray jet (t3) and the points P7 and P6 can be calculated. Here too, it is again possible to ascertain whether this time interval lies within a specified reference range or not.

On the basis of the above-described evaluations, in each case a manual or automatic assessment of the assembly can be carried out.

The testing method can be incorporated into the assembly process of the spray applicator, so that each spray applicator can be evaluated by the testing method (100% testing). Alternatively, random-sample testing of the spray applicators would also be possible.

In the event of integration into the assembly process, it is generally expedient to test each assembly only a few times. In this case, the testing method is preferably carried out three times for each assembly, so that there is a certain statistical certainty. In this way, in particular the reproducibility of the measured values can also be tested, so that an optimal quality test of the corresponding assembly can be implemented. However, it would also be possible to test each assembly only once.

As an alternative, the testing method could also be carried out considerably more frequently with the same assembly. Such a multiple performance of the testing method can in particular be expedient during the trial phase of the assembly process. Furthermore, in this way the quality of the priming (venting of the pump during the first filling of the initial dry pump chamber) can be detected and assessed. A plurality of measurements can be carried out one after another, wherein the duration of the spray jet can be calculated for each measurement. The respectively determined durations of the spray jet can then be evaluated in the order of the measurements. Thus, for example, it is possible to determine the number of triggering actions of the assembly with which the full spraying time is achieved.

The device for testing the spray jet of an assembly for spray applicators has at least one receiving unit for the assembly to be tested, at least one liquid reservoir for a test fluid, and an actuating unit for the assembly to be tested, so that the assembly can be filled with the test fluid and a spray jet can be produced. Furthermore, there is a light barrier with a strip of light or a light beam, which is positioned in front of the assembly to be tested such that the spray jet produced by the assembly to be tested encounters the strip of light or the light beam. The darkening of the strip of light or of the light beam can be detected by means of a sensor unit. There is an integration unit for integrating the measured values recorded by the sensor unit. Furthermore, there is at least one evaluation unit, by means of which the recorded measured values and the integral of the recorded measured values can be evaluated.

The strip of light or the light beam can preferably be a laser beam or a fanned-out laser beam.

The integration unit and/or the evaluation unit can in particular be appropriate software which, for example, can be integrated in a control unit.

It may be sufficient to provide only one individual evaluation unit, by means of which both the recorded measured values and also the integral of the recorded measured values can be evaluated. Alternatively, there can also be a first evaluation unit, by means of which firstly only the recorded measured values are evaluated. The integral of the recorded measured values can then be evaluated by means of a second evaluation unit.

Preferably, there can be a display unit to output the recorded measured values and/or to output the integral of the recorded measured values. The respective data can in particular here be output in the form of line diagrams and/or in tabular form.

Furthermore, the recorded measured values and/or the integral of the recorded measured values and/or the evaluation of the measured values by the evaluation unit can be transmitted to a control unit, possibly including a good/poor assessment.

Preferably, the sensor unit for measuring the darkening value of the light barrier can be started with the actuation of the assembly to be tested.

The liquid reservoir can be, for example, a cartridge filled with a test fluid, which can be inserted into the assembly to be tested. As an alternative, a test body filled with the test fluid, which can likewise be inserted into the assembly to be tested, would also be conceivable. In principle, a larger liquid reservoir which can be used simultaneously for a plurality of assemblies to be tested would also be possible. In this case, the individual assemblies to be tested could each be connected to the liquid reservoir via a coupling element. This coupling element can be, for example, the capillary with the integrated check valve, which represents an important component of the spray applicators. As an alternative, the coupling element can also be a flexible tube, which can be connected to the capillary or the hollow piston of the assembly.

The actuating unit can preferably have an electric or pneumatic trigger.

The assembly to be tested can in particular be a functionally finished spray applicator. As a result, a final inspection of the spray applicator can be implemented. In this case, the finally assembled spray applicator may still not have a mouthpiece cover, since this would hamper testing of the spray jet. In addition, a cartridge having the active substance could also be inserted into the finally assembled spray applicator.

The spray mist expelled should in each case be extracted in order to avoid contaminations and hazards and to ensure explosion protection. The extraction could be configured in such a way that alignment of the spray mist can simultaneously be achieved as a result. The reproducibility of the measurements can be increased by this means.

The operation of the testing device can be implemented manually, semi-automatically or completely automatically. The testing device can be integrated into the assembly process of the inhaler such that each assembly is tested by the testing device, so that 100% testing is carried out. However, random-sample testing would also be possible.

### BRIEF DESCRIPTION OF THE DRAWINGS

The invention is described in more detail and explained below by using the exemplary embodiments illustrated in the drawings.

FIG. 1 shows a schematic line diagram of the measured darkening values with reference ranges drawn in.

FIG. 2 shows a schematic line diagram according to FIG. 1, in which the drop in the darkening values would lead to the rejection of the tested assembly.

FIG. 3 shows a further schematic line diagram according to FIG. 1, in which the drop in the darkening values would lead to the rejection of the tested assembly.

FIG. 4 shows a schematic line diagram according to FIG. 1 with the integral of the measured values additionally drawn in.

FIG. 5 shows a schematic line diagram according to FIG. 4, in which the rise in the integral would lead to the rejection of the tested assembly.

FIG. 6 shows a further schematic line diagram according to FIG. 4, in which the rise in the integral would lead to the rejection of the tested assembly.

FIG. 7 shows a schematic line diagram according to FIG. 4 with the determination of the transition point of the integral.

FIG. 8 shows a schematic diagram of the spray time tₛ as a function of the number of priming strokes.

FIG. 9 shows a schematic diagram according to FIG. 8, which would lead to the rejection of the tested assembly.

FIG. 10 shows a schematic illustration of the device for testing the spray jet of an assembly for spray applicators.

### DETAILED DESCRIPTION

In the testing method for testing the spray jet of an assembly for spray applicators, firstly the assembly to be tested is filled with a defined dose of the test fluid. For this purpose, the assembly to be tested can be connected to an appropriate liquid reservoir. As the assembly to be tested is drawn up, the internal spring of the assembly is tensioned and the test liquid is sucked out of the reservoir. By means of an electrical or pneumatic trigger, the trigger switch on the assembly to be tested is then pressed. At the same time, the recording of the darkening values of the strip of light or of the light beam by the sensor unit begins.

As a result of the triggering of the assembly to be tested, the spring-pre-loaded piston is released and conveys the volume of test fluid sucked in through a micro-nozzle of the assembly at high pressure. This micro-nozzle atomizes the liquid to form a fine spray jet. The spray jet encounters the strip of light, so that the latter is darkened. The darkening values are measured by the sensor unit for an adjustable time and are stored. The storage of the darkening values can be carried out by the sensor unit or by a separate control unit.

The measured darkening values V can then be output in a line diagram in relation to the elapsed time. The darkening values V in an assembly that meets the specification have a typical course, which is illustrated schematically in FIG. 1.

Following the triggering of the assembly (time t1), the pressure in the pump, and therefore the spray jet, generally builds up in a short time. As a result, a steep rise in the darkening values to a virtually stable spray jet 10 with maximum darkening values (Vₘₐₓ) is produced. Once the piston travel has been completed, the system relaxes and the spray jet and therefore also the darkening values decrease (falling spray jet 12).

Via a plurality of algorithms, firstly the start of the spray jet (point P3, time t3) and the end of the spray jet (point P4, time t4) are found from the recorded measured values 14. To this end, the darkening values are firstly scaled by the minimum and maximum of the darkening values being found. The measured values are appropriately scaled between these two extremes. The absolute measured darkening value cannot be used, since this is not normalized. Furthermore, the absolute measured darkening value varies, depending on the exact structure for the testing method and the precise positioning of the light barriers. Scatter in the measurements can also be eliminated by the scaling. If the measurement is carried out in a dark chamber, external light influences can additionally be eliminated.

The time t3 corresponds to the start of the spray jet following the triggering of the assembly to be tested. The time t3 can be detected by the steep rise in the darkening value. The time t4 marks the end of the spray jet. The time t4 is generally determined by the darkening value falling below a certain threshold.

In order to assess an assembly as meeting the specification, the time t3 must lie in a specified reference range 20. The reference range 20 is defined by the triggering time t1. The time t4 must likewise lie in a specified reference range 22. Furthermore, the time interval 24 between t3 and t4 can be calculated. This value 24 (spray time tₛ) must also lie in a specified reference range if it is an assembly that meets the specification.

To a first approximation, the spray time tₛ is proportional to the volume MV (metered volume) sucked in or metered by the pump, based on the volume flow V_{D} of the nozzle, which is assumed to be constant.

$${t}_{s} = \frac{MV}{{\dot{V}}_{D}}$$

The metered volume MV is the volume displaced by the piston when the assembly is triggered and can be calculated from the piston cross section A_{K} and the piston stroke h.

$$MV = {A}_{K} \times h$$

The volume flow V_{D} through the nozzle is given by the formula:

$${\dot{V}}_{D} = {A}_{D} \times {v}_{D}$$

As a result, the spray time tₛ is given by the formula:

$${t}_{s} = \frac{{A}_{K}}{{A}_{D}} \times \frac{h}{{v}_{D}}$$

The exit velocity v_{D} of the medium from the nozzle is calculated by the following formula, with a density ρ of the medium for steady-state flows without considering the losses:

$${v}_{D} = \sqrt{2 \frac{p}{ρ}}$$

The pressure p is calculated from the mean piston force F_{K} and the piston cross section A_{K} by way of the following formula:

$$p = \frac{{F}_{K}}{{A}_{K}}$$

The spray time tₛ is thus given by the following formula:

$${t}_{s} = \frac{{A}_{K}}{{A}_{D}} \times \frac{h}{\sqrt{2 \times \frac{{F}_{K}}{{A}_{K} \times ρ}}}$$

Thus, via the measurement of the spray time tₛ, relatively large deviations can be detected immediately and the tested assemblies can be discharged as poor.

Because of the multi-parameter dependency, the cause of the deviation can generally not be assigned unambiguously at first. However, this can possibly be carried out by means of re-inspection of the individual components of the assembly.

In addition to the geometric variables piston cross section A_{K}, nozzle cross section A_{D} and piston stroke h, the spray time tₛ also includes the piston force F_{K}.

In practice, frictional forces are also established, which are then expressed in a reduction in the effective piston force F_{K} and thus in the spray time tₛ.

Apart from the geometric and force-based dependencies of the spray time tₛ, deviations from the target can also be detected as leaks in the area of the check valve or the elastomer seals. The reason for this is that the theoretically possible “Metered Volume” MV (MV=A_{K}×h) is reduced by the “leakage volume” LV when leakage losses occur:

$$MV = {A}_{K} \times h - LV$$

Because of the proportionality between the spray time and the “metered volume” MV, the spray time is thus reduced when leakage losses occur.

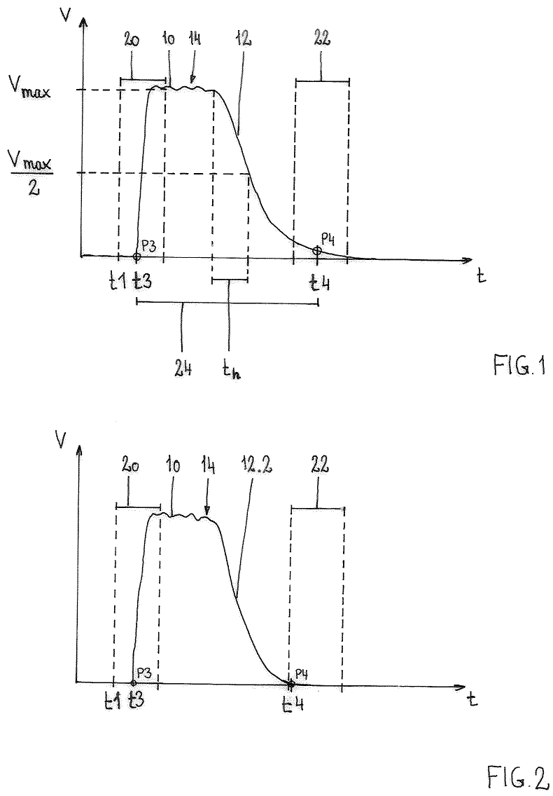

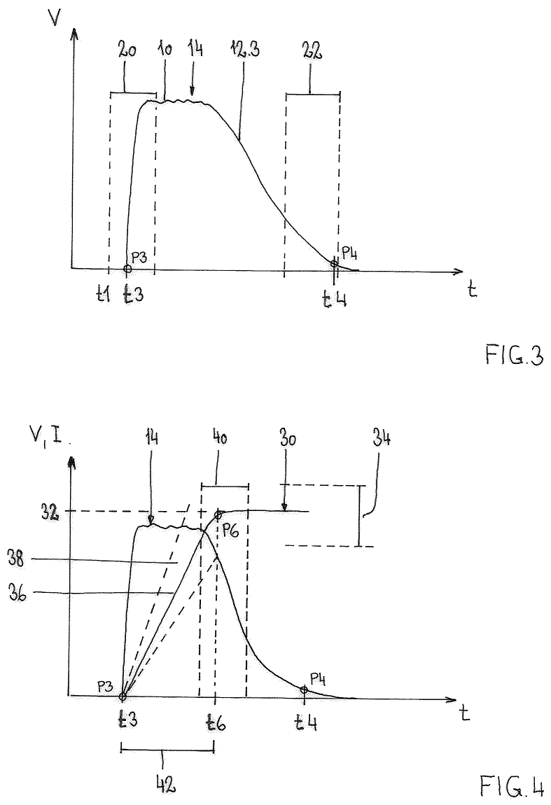

Furthermore, the line course in the region of the falling spray jet 12 can be evaluated, since this is very characteristic of the quality of the micro-nozzle of the assembly to be tested. The line course in FIG. 1 corresponds to an assembly that meets the specification. On the other hand, the line courses of assemblies that do not meet the specification are illustrated in FIGS. 2 and 3. Both in the measurement in FIG. 2 and also in the measurement in FIG. 3, the times t3 and t4 lie within the specified reference ranges 20, 22. However, the line course 12.2 in FIG. 2 falls considerably more steeply than in the assembly that meets the specification according to FIG. 1. This implies that there is too large an opening of the micro-nozzle. In FIG. 3, on the other hand, the line course 12.3 falls considerably more slowly than in the assembly that meets the specification according to FIG. 1. This implies that there is a narrowing of the micro-nozzle, for example as a result of contamination of the micro-nozzle.

Furthermore, from the approximately exponentially falling line course in the region of the falling spray jet 12, a determination of the half-value time tₕ (50% of the maximum darkening value) can be made (see FIG. 1). From this half-value time tₕ, the hydraulic flow resistance Rₕ of the nozzle can be determined via the formula

$${t}_{h} = {R}_{h} \times {C}_{h} \times ln \qquad ( 2 )$$

It can be assumed that Cₕ (hydraulic capacity or flexibility of the pump body) is constant. Therefore, given a high half-value time tₕ, it can be concluded that there is a high flow resistance Rₕ. Since the half-value time tₕ is independent of the drive variables (in particular of the spring and of the friction within the assembly) when the flexibility of the pump body is assumed to be constant, this is very specific for the flow resistance Rₕ of the nozzle.

The measured darkening values can then be integrated over the duration 24 of the spray jet. The corresponding integral 30 can likewise be output as a line diagram, as illustrated in FIG. 4. In the present example, both the actual measured values 14 and the integral 30 are illustrated in a common diagram. As opposed to this, the integral 30 could also be output in an independent diagram.

The expelled volume of the spray jet 10, 12 is proportional to the end value or maximum 32 of the integral 30. The maximum 32 of the integral 30 must lie in a specified reference range 34 in order that this can be an assembly that meets the specification.

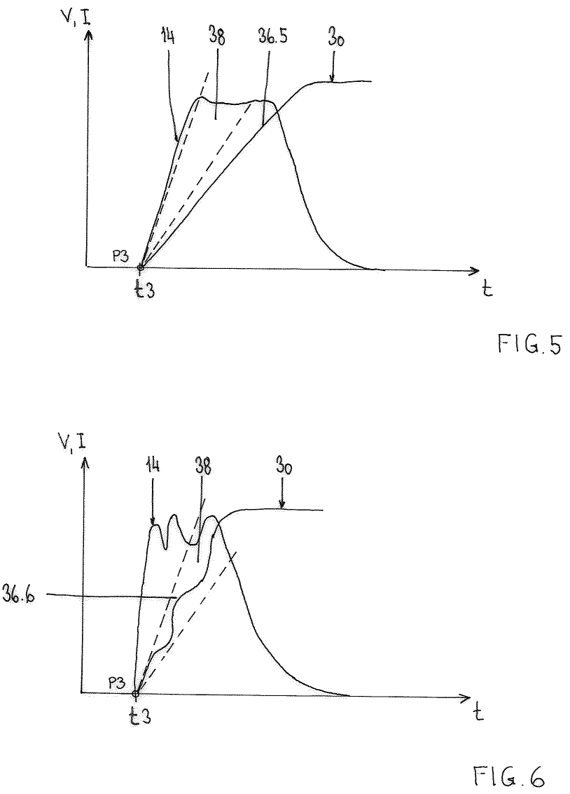

Furthermore, the rising line course 36 of the integral 30 during the spray jet 10 can be evaluated. The line course in FIG. 4 corresponds to an assembly that meets the specification. On the other hand, the line courses of assemblies that do not meet the specification are illustrated in FIGS. 5 and 6. Thus, the rising line course 36.5 in FIG. 5 lies outside the specified reference range 38. In FIG. 6, although the line course 36.6 lies within the specified reference range 38, the slope of the line course 36.6 is not constant. Instead, the line course 36.6 has a plurality of indentations. This suggests that the piston of the assembly to be tested does not run continuously. The assembly to be tested thus does not meet the specification and can therefore be discharged as “poor”.

Furthermore, the point P6 (time t6) can be determined from the integral 30. This is a defined percentage range of the maximum 32 of the integral 30, which can be defined as the end of the spray jet. This time t6 must likewise lie in a specified reference range 40. In a second step, the time interval 42 between the start of the spray jet (time t3) and the time t6 can be calculated. This time interval 42 must lie in a specified reference range if this is an assembly that meets the specification.

Alternatively or additionally to determining the time t6, the transition point P7 of the integral (time t7) can also be determined (see FIG. 7). The transition point P7 of the integral 30 must likewise lie in a specified reference range 44. P7 can also be used to determine the spray time, by the time interval 46 between the start of the spray jet (time t3) and the point P8 being calculated. Here, too, it is again true that the time interval 46 must lie in a specified reference range if this is an assembly that meets the specification.

Optionally, the actually measured darkening values 14 and/or the evaluation results such as, in particular, the integral 30 can be output to an HMI graphically via an XY diagram. The stored darkening values and evaluation results can also be output in tabular form in a CSV file.

For a service life test of the assembly to be tested, the complete testing cycles can be repeated as often as desired. All individual measurements, evaluation results of the individual tests and the overall result can be detected in real time, indicated on the HMI and/or output as a CSV file.

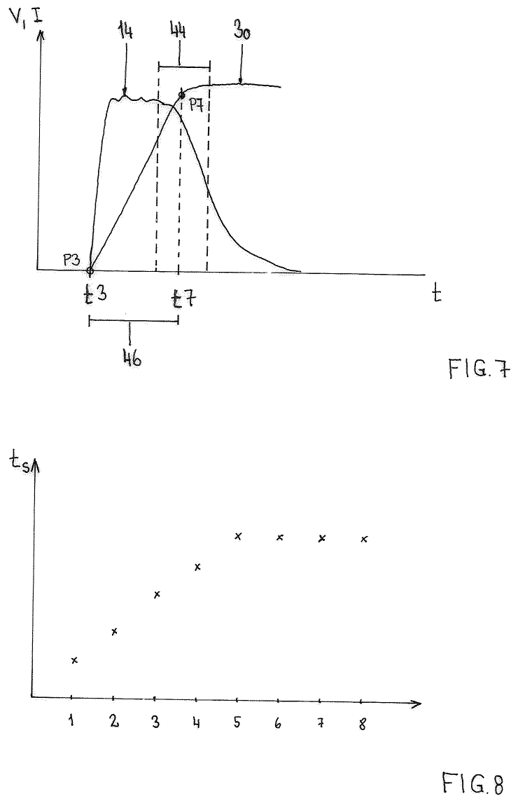

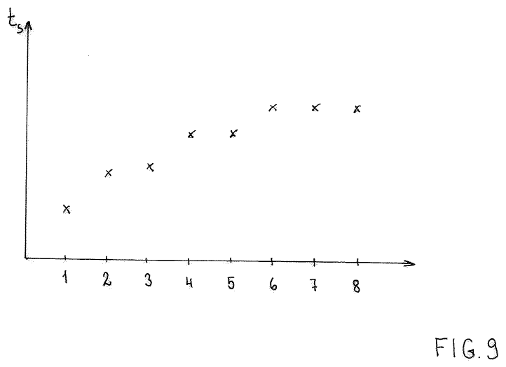

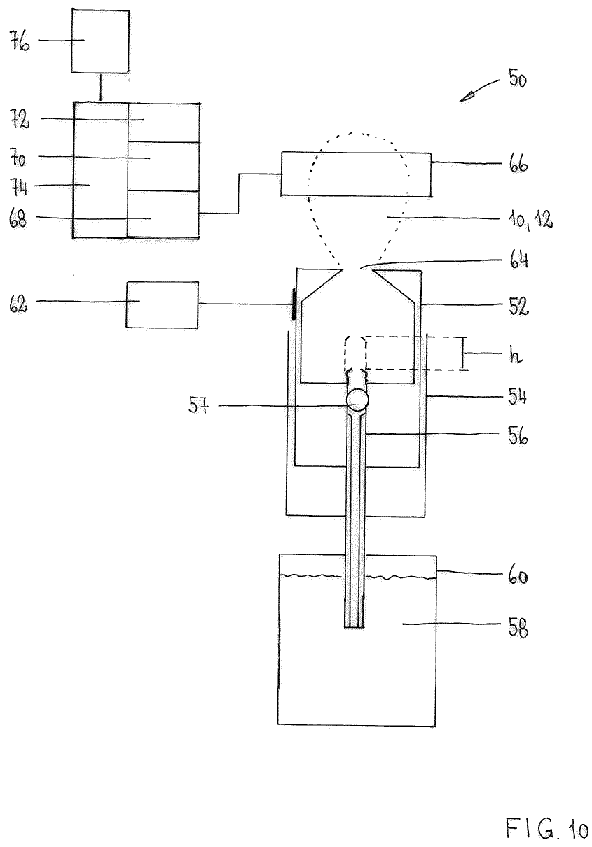

The quality of the priming (venting of the pump during the first filling of the initially dry pump chamber) can also be detected and evaluated. For example, it is possible to determine the number of triggering actions of the assembly with which the full spray time is achieved (see FIGS. 8 and 9). An assembly that meets the specification is illustrated in FIG. 8. In this case, the spray time tₛ rises approximately constantly within the first five priming strokes. Then, the spray time tₛ remains approximately constant. By contrast, the rise of the spray time tₛ in the diagram according to FIG. 9 does not run constantly. The uniformity of the rise can thus be used as a quality feature, which, in a diagram comparable with FIG. 9, would lead to rejection of the assembly that does not meet the specification. In this way, for example, a check valve that operates poorly can be discovered on the basis of a poor response or sealing.

FIG. 10 shows a schematic illustration of the device 50 for testing the spray jet 10, 12 of an assembly 52 for spray applicators. The device 50 has a receiving unit 54, into which the assembly 52 to be tested can be inserted. In the present example, the assembly 52 to be tested with its capillary 56 and the check valve 57 can be connected to a liquid reservoir 60 filled with a test fluid 58. The liquid reservoir 60 can be, for example, a test cartridge. Alternatively, the liquid reservoir 60 can also be designed to be larger, so that a plurality of receiving units 54 can be connected to a common liquid reservoir 60.

The device 50 has an actuation unit 62, via which the assembly 52 to be tested can be tensioned and actuated, so that a spray jet 10, 12 is liberated from the nozzle 64 of the spray applicator. The spray jet 10, 12 encounters a strip of light 66 which is positioned in front of the nozzle 64 and which is darkened by the spray jet 10, 12. The darkening values 14 are measured by the sensor unit 68 and, in the present example, are also stored. Furthermore, there is an integration unit 70, by means of which the recorded measured values 14 can be integrated. The integration unit 70 can in particular be appropriate software which, for example, can be integrated in a control unit. In the present example, both the recorded measured values 14 and the integral 30 of the recorded measured values are evaluated by an evaluation unit 72. The measured values 14 determined and the integral 30 of the measured values 14 determined are displayed on a display unit 74.

Furthermore, there can be a control unit 76. This control unit 76 can optionally also be assigned to a higher-order device, in particular an assembly device for the assemblies to be tested. By means of the control unit 76, the good/poor assessments determined can be assigned to the individual assembly, and their further processing can be controlled appropriately.

What is claimed is:

1. A method for testing a spray jet (10, 12) of an assembly for spray applicators, the method comprising:
positioning the assembly to be tested in a receiving unit of a testing device and connecting the assembly to a liquid reservoir;
tensioning the assembly to be tested, causing the assembly to suck in a specific volume of a test fluid from the liquid reservoir;
actuating the assembly to be tested and thereby producing the spray jet (10, 12);
darkening, by the spray jet (10, 12), a strip of light or a light beam of a light barrier;
measuring the darkening of the strip of light or the light beam by a sensor unit and registering and evaluating measured values (14) of the darkening as a function of time; and
calculating, based on the measured values (14), a start (t3) of the spray jet (10) and/or an end (t4) of the spray jet (12) and/or a duration (24) of the spray jet (10, 12).

2. The method according to claim 1, further comprising
ascertaining whether the start (t3) of the spray jet (10) and/or the end (t4) of the spray jet (12) lies in a specified reference range (20, 22).

3. The method according to claim 1, further comprising
ascertaining whether the duration (24) of the spray jet (10, 12) lies in a specified reference range.

4. The method according to claim 1, further comprising
outputting the measured values (14) in a line diagram and/or in tabular form.

5. The method according to claim 4, further comprising
ascertaining whether a falling line course towards the end of the spray jet (12) lies in a specified reference range.

6. The method according to claim 1, further comprising
integrating the measured values (14), at least in a range between the start (t3) of the spray jet (10) and the end (t4) of the spray jet (12), and
evaluating an integral (30) of the measured values (14).

7. The method according to claim 6, further comprising
outputting the integral (30) of the measured values (14) in a line diagram and/or in tabular form.

8. The method according to claim 7, further comprising
ascertaining whether a rise (36, 36.5, 36.6) of the integral (30) lies in a specified reference range (38).

9. The method according to claim 8, further comprising
ascertaining whether the rise (36, 36.5, 36.6) of the integral (30) runs approximately linearly.

10. The method according to claim 6, further comprising
ascertaining whether a maximum (32) of the integral (30) lies in a specified reference range (34).

11. The method according to claim 6, further comprising
determining a transition point (P7) of the integral (30).

12. The method according to claim 10, further comprising
determining exceeding a defined percentage of the maximum (32) of the integral (30) as the end (P6) of the spray jet (10).

13. The method according to claim 11, further comprising
ascertaining whether the transition point (P7) or the end (P6) of the spray jet (10) lies in a specified reference range (44, 40).

14. The method according to claim 11, further comprising
calculating a time interval (46, 42) between the transition point (P7) of the integral (30) or the end (P6) of the spray jet (10) and the start (P3) of the spray jet, and
ascertaining whether the time interval (46, 42) lies in a specified reference range.

15. The method according to claim 1,
wherein the method steps are carried out multiple times one after another,
wherein the duration (24) of the spray jet (10, 12) is calculated for each measurement, and
wherein the durations (24) of the spray jet are evaluated in order of the measurements.

16. The method according to claim 15, further comprising
outputting durations (24) of the spray jet in a line diagram and/or in tabular form.

17. A device (50) for testing a spray jet (10, 12) of an assembly (52) for spray applicators, comprising:
at least one receiving unit (54) for the assembly (52) to be tested;
at least one liquid reservoir (60) for a test fluid (58);
an actuating unit for the assembly (52) to be tested;
a light barrier with a strip of light (66) or a light beam, the light barrier being positioned in front of the assembly (52) to be tested such that the spray jet (10, 12) produced by the assembly (52) to be tested encounters the strip of light (66) or the light beam;
a sensor unit (68), by which a darkening of the strip of light (66) or the light beam can be measured;
an integration unit (70) for integrating recorded measured values (14) indicative of the darkening; and
at least one evaluation unit (72) for evaluating the recorded measured values (14) and the integral (30) of the recorded measured values (14).

18. The device according to claim 17, further comprising
a display unit (74) for outputting the recorded measured values (14) and/or for outputting the integral (30) of the recorded measured values (14) in line diagrams and/or in tabular form.

19. The device according to claim 17,
wherein the light barrier has a laser beam or a fanned-out laser beam.
